(19) United States
(12) Patent Application Publication
(10) Pub. No.: US 2026/0164527 A1
(43) Pub. Date: Jun. 11, 2026

(54) DEVICE FOR DISCHARGING STATIC ELECTRICITY AND METHOD THEREOF

(71) Applicants: HSIN-HAU HUANG, Hsinchu City (TW); MESOSCOPE TECHNOLOGY CO., LTD., Hsinchu City (TW)

(72) Inventor: Hsin-Hau Huang, Hsinchu City (TW)

(73) Assignees: HSIN-HAU HUANG, Hsinchu City (TW); MESOSCOPE TECHNOLOGY CO., LTD., Hsinchu City (TW)

(21) Appl. No.: 19/379,781

(22) Filed: Nov. 5, 2025

(30) Foreign Application Priority Data
Dec. 5, 2024 (TW) 113147258
Sep. 26, 2025 (CN) 202511392342.7

(51) Int. Cl. H05F 3/00; H01M 10/42; H01M 50/213; H01M 50/24; H01M 50/247; H01M 50/51

(52) U.S. Cl. CPC H05F 3/00; H01M 10/425; H01M 50/213; H01M 50/24; H01M 50/247; H01M 50/51; H01M 2220/30

(57) ABSTRACT

Provided is a device for discharging static electricity. The device for discharging static electricity includes a receiving chamber, a battery pack, a conductor, a switch, and an electrical connector. The receiving chamber is configured to accommodate a carrier that carries the battery pack. The battery pack includes a first battery and a second battery connected in series with each other. The conductor includes a zero potential node located between a first electrode of the first battery and a second electrode of the second battery. The switch is configured to switch an electrical connection state between the electrical connector and the battery pack. The electrical connector is electrically connected to the zero potential node and coupled to a detection device to allow an electrostatic discharge path to be formed between the zero potential node and the detection device.

### CROSS-REFERENCE TO RELATED APPLICATION

This application claims the priority benefit of Taiwan application serial no. 113147258, filed on Dec. 5, 2024, and Chinese application serial no. 202511392342.7, filed on Sep. 26, 2025. The entirety of each of the above-mentioned patent applications is hereby incorporated by reference herein and made a part of this specification.

### BACKGROUND

### Technical Field

The disclosure relates to a device for discharging static electricity, particularly a device for discharging static electricity configured for a detection device that can detect a micro-nano level element, and a method for discharging static electricity using the device for discharging static electricity.

### Related Art

In a manufacturing and preparation process of a semiconductor device (such as a chip, a wafer, a transistor, an integrated circuit, or other micro-nano level electronic elements), a detection equipment equipped with a probe may be typically used to test parameters such as voltage, current, resistance, or communication data on the semiconductor device to execute quality inspection and process control. The detection steps may facilitate the assurance of the electrical performance of the semiconductor device to meet a design specification and enhance product reliability and yield.

An existing detection method typically involves controlling a probe on an operating table through manual operation or using an inspection tool (such as an automatic detection device equipped with a mechanical arm capable of clamping the probe) to perform electrical detection for multiple points to be tested on a semiconductor circuit. However, during an actual process of detection, a circuit board often may not be effectively fixed, resulting in insufficient probe positioning accuracy, thereby affecting detection efficiency and accuracy. In addition, electrostatic accumulation might be generated between an operator, the circuit board, and the operating table. Electrostatic discharge (ESD) has a significant impact on an electrical test result and product quality of the semiconductor device, and might even cause element damage. Therefore, the industry commonly utilizes various electrostatic protection measures to reduce interference of static electricity on the detection process and ensure reliability of the test result and product quality.

In the past, to effectively discharge static electricity, the industry has commonly utilized various technologies for discharging static electricity, including methods such as tip discharge, ion neutralization, electrostatic isolation, airflow dust removal, and ground discharge. Tip discharge is to utilize a high electric field intensity generated at a conductor tip to ionize the surrounding air, thereby discharging electrons to neutralize static charges. Ion neutralization actively discharges positive and negative ions through an ion generator, facilitating neutralization of static charges on a surface of a charged object and reducing a risk of electrostatic accumulation. Electrostatic isolation effectively blocks a transmission of static charges to a sensitive electronic element by selecting a high insulation material or designing an isolation structure. Airflow dust removal uses airflow to blow away charged particles or dust adhering to a surface of an element, further decreasing a risk of electrostatic accumulation and particle contamination. Ground discharge is to connect a charged body to a ground, using a low impedance path to guide static charges to the ground, thereby preventing electrostatic discharge (ESD) from causing damage to the electronic element.

However, existing technologies for discharging static electricity often may not completely discharge static electricity, and some static charges might still remain. Taking ground discharge as an example, a conventional method typically uses a wire to connect an equipment that needs to discharge static electricity to the ground, and takes a metal structure within a building (such as a steel frame structure in a building) to serve as an electrostatic discharge path. However, the metal structure often has reduced conductivity due to impurities or a surface oxide layer, thereby affecting an effective discharge of static charges and may not achieve the effect of completely discharging static electricity. This problem is particularly critical in high-precision electronic processes, such as the manufacturing of semiconductor devices, the assembly of precision circuits, and the detection of circuit quality, because even an extremely small amount of residual static electricity might generate a significant impact on process stability, product yield, or detection accuracy.

In summary, how to provide a device for discharging static electricity adapted for a detection equipment for detecting a micro-nano level element to effectively and thoroughly discharge static charges generated during a detection process, thereby avoiding static electricity from damaging the element, is a technical problem that urgently needs to be solved in the industry.

### SUMMARY

In some embodiments, the disclosure provides a device for discharging static electricity, which includes a receiving chamber, a battery pack, a conductor, a switch, and an electrical connector. The battery pack is disposed in the receiving chamber. The battery pack includes a first battery and a second battery connected in series with each other, and each of the first battery and the second battery has a first electrode and a second electrode. The conductor is connected in series to the battery pack. The conductor includes a zero potential node located between the first electrode of the first battery and the second electrode of the second battery. The switch is electrically connected to the conductor, and configured to switch an electrical connection state between the conductor and the battery pack. The electrical connector is electrically connected to the zero potential node, and coupled to a detection device to allow an electrostatic discharge path to be formed between the zero potential node and the detection device.

In one embodiment of the disclosure, a quantity of batteries included in the battery pack is an even number.

In one embodiment of the disclosure, the conductor includes at least one of a wire, a conductive pattern, a conductive sheet, a conductive adhesive, a conductive tape, a conductive fabric, and a conductive foam.

In one embodiment of the disclosure, the device for discharging static electricity further includes an indicating light source. The indicating light source is configured to send an indication signal in response to the electrical connection state.

In one embodiment of the disclosure, the device for discharging static electricity further includes a portable outer box body having the receiving chamber.

In one embodiment of the disclosure, the device for discharging static electricity further includes an outer box body having the receiving chamber. The outer box body is configured to be attached and fixed to the detection device.

In one embodiment of the disclosure, the detection device has a probe configured to detect a micro-nano level element.

In one embodiment of the disclosure, a voltage value of an electrostatic discharge generated through the electrostatic discharge path is less than 10 volts.

In one embodiment of the disclosure, the device for discharging static electricity further includes an alert device. The alert device is electrically connected to the electrostatic discharge path, and configured to reflect an electrostatic discharge state of the electrostatic discharge path.

In one embodiment of the disclosure, the battery pack further includes at least one third battery connected in series to the second electrode of the first battery, and at least one fourth battery connected in series to the first electrode of the second battery. A quantity of the at least one third battery is equal to a quantity of the at least one fourth battery.

In one embodiment of the disclosure, the device for discharging static electricity further includes an adjustment element. The adjustment element is electrically connected to the conductor and the detection device, and configured to adjust a resistance value between the conductor and the detection device.

In some embodiments, the disclosure provides another device for discharging static electricity, which includes a battery pair and a conductor. The battery pair includes two batteries connected in series with each other, and battery pairs may be connected in series with each other. The conductor is connected in series to the battery pair to form an electrical circuit, and forms a zero potential node between opposite electrodes of the battery pair. The zero potential node is configured to be electrically coupled to a detection device to form an electrostatic discharge path.

In one embodiment of the disclosure, the detection device is configured to use a probe to detect a micro-nano level element.

In one embodiment of the disclosure, a voltage value of an electrostatic discharge generated through the electrostatic discharge path is less than 10 volts.

In one embodiment of the disclosure, the device for discharging static electricity further includes a portable box body accommodating a carrier carrying the battery pair therein, wherein the battery pair is electrically connected to the carrier.

In one embodiment of the disclosure, an outer surface of the portable box body is provided with a switch. The switch is configured to turn on or turn off the electrical circuit.

In one embodiment of the disclosure, the outer surface of the portable box body is provided with an indicating light source. The indicating light source is configured to send an indication signal in response to an electrical connection state of the electrical circuit.

In one embodiment of the disclosure, the battery pair includes a battery panel, and is mounted on a flexible substrate.

In one embodiment of the disclosure, the device for discharging static electricity is configured to be integrated into a wearable device.

In some embodiments, the disclosure provides a method for discharging static electricity. The method includes: a battery pack is provided; a conductor is provided; the conductor is connected in series with a first battery and a second battery in the battery pack; the conductor, the first battery and the second battery are turned on to form an electrical circuit, and a zero potential node is formed between a first electrode of the first battery and a second electrode of the second battery; the zero potential node is electrically coupled to a detection device; a static electricity generated by the detection device is discharged to the zero potential node through an electrostatic discharge path formed between the detection device and the zero potential node; and the detection device has a probe configured to detect a micro-nano level element.

In another embodiment of the disclosure, a manufacturing system is further provided. The manufacturing system is configured to manufacture a probe card. The manufacturing system provides multiple probes, and assembles the probes on a guide plate and a space conversion unit. The manufacturing system includes the foregoing device for discharging static electricity.

The disclosure further provides a manufacturing system, which is configured to manufacture a probe holder. The manufacturing system provides multiple probes, assembles the probes on a guide plate and a space conversion unit with a frame or a casing, and is electrically connected to a detection device. The manufacturing system includes the foregoing device for discharging static electricity. The device for discharging static electricity has two batteries connected in series to form an offsetting potential point.

The disclosure further provides a manufacturing system, which is configured to provide a probe card to analyze a semiconductor element. The probe card provides multiple probes, assembles the probes one by one on a guide plate and a space conversion unit, and analyzes at least one object to be tested through at least one needle tip of the probe. The manufacturing system includes the foregoing device for discharging static electricity.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure.

### BRIEF DESCRIPTION OF THE DRAWINGS

FIG. 1 is a perspective schematic view of a device for discharging static electricity according to a first embodiment of the disclosure.

FIG. 2 is a schematic view of a detection device according to an embodiment of the disclosure.

FIG. 3 is a schematic view of a device for discharging static electricity according to a second embodiment of the disclosure.

FIG. 4 is a schematic view of a device for discharging static electricity according to a third embodiment of the disclosure.

FIG. 5 is a schematic view of a device for discharging static electricity according to a fourth embodiment of the disclosure.

FIG. 6 is a schematic view of a device for discharging static electricity according to a fifth embodiment of the disclosure.

FIG. 7 is a schematic view of a device for discharging static electricity according to a sixth embodiment of the disclosure.

FIG. 8 is a schematic view of the device for discharging static electricity integrated into a wearable device according to the sixth embodiment.

### DESCRIPTION OF THE EMBODIMENTS

In order to facilitate the understanding of the technical features, content, and advantages of the disclosure and the effects that can be achieved, the disclosure is described in detail with the embodiment and the accompanying drawings as follows. The drawings used are only for the purpose of illustration and assisting the specification, and may not be the true proportion and precise configuration after the implementation of the disclosure. Therefore, the proportion and configuration relationship of the drawings should not be interpreted as limiting the scope of the claims of the actual implementation of the disclosure.

As used herein, “about,” “approximately” or “substantially” includes the values as mentioned and the average values within the range of acceptable deviations that can be determined by those of ordinary skill in the art.

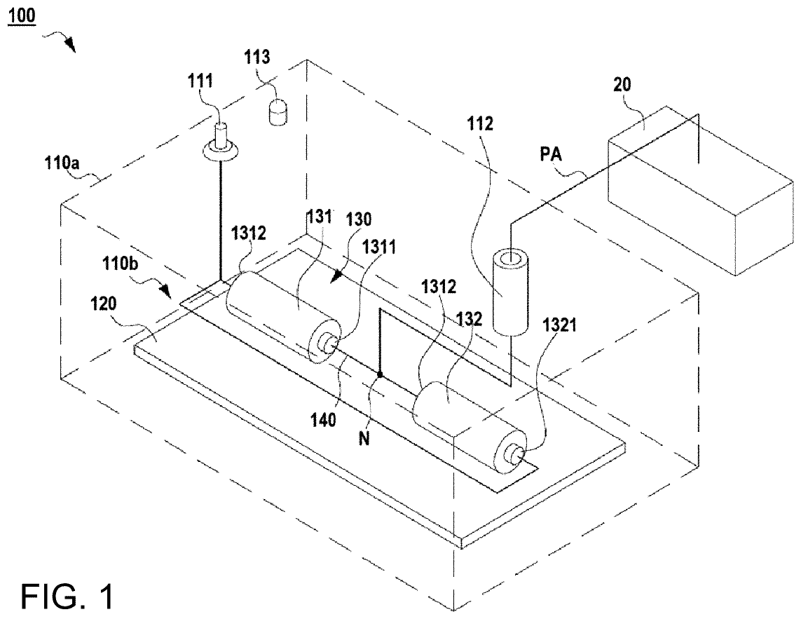

Please refer to FIG. 1, which is a perspective schematic view of a device for discharging static electricity 100 according to a first embodiment of the disclosure. In some embodiments, the device for discharging static electricity 100 has a box-shaped structure with an outer box body 110a configured externally, and a receiving chamber 110b formed internally. The receiving chamber 110b may be configured to accommodate a carrier 120. In some embodiments, the carrier 120 may be a printed circuit board (PCB), a flexible PCB, a flexible substrate, a flexible display substrate, a vapor chamber, a space transformer, a perovskite solar panel, a ceramic substrate, or other substrate structures having good electrical insulation and thermal stability.

The carrier 120 may carry a battery pack 130 disposed thereon. The battery pack 130 may be composed of one or more battery units paired and connected in series, that is, a quantity of the batteries included is an even number. In the embodiment shown in FIG. 1, the battery pack 130 includes a first battery 131 and a second battery 132 connected in series with each other. The first battery 131 has a first electrode 1311 (such as a positive electrode) and a second electrode 1312 (such as a negative electrode). The second battery 132 also has a first electrode 1321 (such as a positive electrode) and a second electrode 1322 (such as a negative electrode).

In some embodiments, a terminal voltage provided by a battery unit (such as the first battery 131 or the second battery 132) utilized in the battery pack 130 may be between 0V and 12V. The battery unit may be a button battery, or a cylindrical DC dry battery, and may be a disposable battery or a rechargeable battery with repeated charging functions. Furthermore, the foregoing battery unit may be selected from, including but not limited to, the following types: a low-voltage lithium metal battery (such as Li—MnO₂), a lithium manganese oxide button cell battery, a lithium thionyl chloride battery (Li—SOCl₂), or other lithium-ion batteries and lithium polymer batteries with similar characteristics. In other embodiments, the foregoing battery unit may also be in the form of a battery panel, such as a perovskite battery panel, or other similar thin-film solar battery panels, such as dye-sensitized solar batteries (DSSC), copper indium gallium selenide batteries (CIGS) or amorphous silicon solar batteries (a-Si). In addition, in some embodiments, the battery pack 130 may be composed of battery units of a same type and specification to ensure a terminal voltage between each battery pair to retain consistency.

To ensure the consistency of a terminal voltage between the first battery 131 and the second battery 132 in the battery pack 130, so as to maintain the stability of a zero potential node N, the disclosure provides the following measures. First, a battery unit utilized in the battery pack 130 (such as the first battery 131 and the second battery 132) should be batteries of a same model, batch and specification, for example, a same chemical composition (such as lithium manganese oxide) and a rated voltage (such as 3V). During a process of battery assembly, an initial voltage screening should be performed on each battery through a precision voltage measurement equipment (such as a digital voltmeter) to ensure that a voltage difference is less than 0.01V, so as to reduce voltage unevenness caused by a manufacturing difference.

In addition, to further ensure voltage consistency of the battery pack 130 during long-term usage, the disclosure may selectively include a voltage balancing circuit. The circuit is electrically connected between the first battery 131 and the second battery 132. The voltage balancing circuit may include a microcontroller unit (MCU) and a voltage sensor, and is configured to monitor a terminal voltage of each battery in real time. When it is detected that a voltage difference exceeds a preset threshold (such as 0.05V), the voltage balancing circuit may partially discharge the battery with a higher voltage through a manner of resistor shunting or charge transfer to balance the voltages of the two batteries. The voltage balancing circuit may be integrated on the carrier 120 and electrically coupled to the battery pack 130 through the conductor 140.

To address voltage offset caused by battery aging or different discharge rates, the disclosure further provides a battery state monitoring and maintenance mechanism. In some embodiments, the device for discharging static electricity 100 may include a battery state indicator (such as an LED indicator light or a digital display on the outer box body 110a), and is configured to display a remaining power or voltage state of the battery pack 130. When a battery voltage is lower than a preset value (such as 80% of a rated voltage) or a voltage difference between two batteries exceeds a safe range (such as 0.1V), the indicator may send a visual or audible alert to prompt the user to replace the battery.

In addition, the stability of a battery voltage might be affected by an environmental condition (such as temperature or humidity). To ensure the stability of the zero potential node N under different environments, the battery pack 130 should be a battery unit having the characteristics of high temperature stability and low internal resistance, such as a lithium thionyl chloride battery (Li—SOCl₂). In some embodiments, the device for discharging static electricity 100 may further include a temperature compensation module. The temperature compensation module monitors an environmental temperature through a thermistor or other temperature sensing elements, and adjusts an operating parameter of a voltage balancing circuit according to temperature change to maintain the consistency of the battery voltage. The foregoing measures ensure the device for discharging static electricity 100 may stably operate in various application scenes (such as cleanrooms, laboratories, or outdoor test environments).

The device for discharging static electricity 100 further includes a conductor 140, which is configured to commonly form an electrical circuit with the battery pack 130. In some embodiments, the conductor 140 may include at least one of a wire, a conductive pattern, a conductive sheet, a conductive adhesive, a conductive tape, a conductive fabric, a conductive foam, or other conductive elements having similar functions.

In a specific configuration, the conductor 140 may be connected in series between specific electrodes on the inside of the battery pack 130. For example, in one embodiment, the conductor 140 may be connected in series between a positive electrode (the first electrode 1311) of the first battery 131 and a negative electrode (the second electrode 1322) of the second battery 132. In some embodiments, since the first electrode 1311 of the first battery 131 and the second electrode 1322 of the second battery 132 have terminal voltages with a same magnitude but opposite polarities, when the battery pack 130 forms an electrical circuit through the conductor 140, the zero potential node N with mutually canceling potentials may be formed between the two electrodes. Since an electric potential of the zero potential node N is 0V, it may serve as an electrically neutral point, thereby providing a stable reference point for electrostatic collection and conduction.

To ensure the potential stability of the zero potential node N, so as to maintain the efficiency and reliability of the device for discharging static electricity 100 during an electrostatic discharge process, the disclosure provides an anti-electromagnetic interference design. In some embodiments, the outer box body 110a of the device for discharging static electricity 100 is made of a conductive material (such as an aluminum alloy or a copper shielding layer), forming a Faraday cage structure, which is configured to shield external electromagnetic interference (EMI), for example, radio frequency interference from a detection equipment or surrounding electronic device. The shielding structure may guide an external electromagnetic field to a surface of the outer box body 110a and discharge through a ground terminal (if any) or the zero potential node N, thereby ensuring that the potential of the zero potential node N is not interfered and maintained within a stable range of 0V±0.01V.

In some exemplary embodiments, the device for discharging static electricity 100 may be electrically coupled with a detection device 20 and form an electrostatic discharge path PA therewith. Specifically, the device for discharging static electricity 100 may establish the electrostatic discharge path with the detection device 20 through an electrical connector 112. The electrical connector 112 may be disposed on the outer box body 110a of the device for discharging static electricity 100 and electrically connected to the zero potential node N with a wire or other conductive elements having similar functions (such as a conductive sheet or a conductive tape). In some embodiments, the electrical connector 112 may include a socket of banana connectors, with a corresponding plug terminal being pre-electrically connected to the detection device 20 that is subject to discharge static electricity. In this way, when the user inserts the plug terminal into the corresponding socket, the stable electrostatic discharge path PA may be established between the device for discharging static electricity 100 and the detection device 20. Thereby, the detection device 20 may conduct a static charge to be released into an electrical circuit including the battery pack 130 and the conductor 140 through the electrostatic discharge path PA established between the detection device 20 and the device for discharging static electricity 100, thereby effectively discharging the static charge generated during a detection process.

To ensure that a current during a process of electrostatic discharge is controlled within a safe range to avoid the detection device 20 or a device to be tested (such as a micro-nano level element) from being damaged, the disclosure provides a current limiting mechanism. The mechanism is integrated into the electrostatic discharge path PA. In some embodiments, a current limiting resistor is connected in series between the electrical connector 112 of the device for discharging static electricity 100 and the zero potential node N. A resistance value of the current limiting resistor ranges between 10Ω and 1000Ω. A specific value may be adjusted according to an electrostatic tolerance capability of an element to be tested. The current limiting resistor may effectively reduce an instantaneous current peak value during the process of electrostatic discharge, ensuring that the discharge current is controlled within a safe range to protect a sensitive electronic element.

In addition, to further enhance the safety of electrostatic discharge, the disclosure may selectively include a transient suppression element, such as a transient voltage suppressor (TVS) or a metal oxide varistor (MOV). The element is connected in parallel in the electrostatic discharge path PA between the electrical connector 112 and the detection device 20. When electrostatic discharge generates an instantaneous high voltage or high current, the transient suppression element may be rapidly turned on, diverting excess current to the zero potential node N, thereby preventing a current or a voltage from exceeding a tolerance range of the element to be tested. The transient suppression element may be integrated on the carrier 120, and electrically coupled to the electrical connector 112 through the conductor 140.

To implement real-time monitoring and protection, the device for discharging static electricity 100 may further include a current monitoring module. The module is electrically connected to the electrostatic discharge path PA, and configured to measure a magnitude of a discharge current. In some embodiments, the current monitoring module includes a current sensor (such as a Hall effect sensor) and a microcontroller unit (MCU) configured for real-time recording of a peak value and a duration of a discharge current. If the discharge current is detected to exceed a preset safety range, the module may trigger a protection mechanism, for example, automatically turning off the electrostatic discharge path PA through a switch element 111, or sending a visual or audible alarm through an alert device (such as an alert device 50 of the embodiment described below) to prompt the user to check the system state. In another feasible implementation example, a microcontroller unit of the device for discharging static electricity 100 may integrate at least one communication unit. When a discharge current is detected to exceed a preset safety range, the module may trigger a protection mechanism, and an abnormal record may be transmitted to a built-in memory of the device for discharging static electricity 100 or transmitted to at least one storage unit (which may be local or in a cloud) of at least one manufacturing system that may accept the abnormal record, which is configured to record information, such as production batch, material number and time, to facilitate subsequent procedures such as quality control or sampling inspection.

An impedance design of the electrostatic discharge path PA is also critical to current control. In some embodiments, the conductor 140 and the electrical connector 112 are made of a low impedance conductive material (such as a copper or silver wire with resistivity less than 1.68×10⁻⁸Ω·m), and ensured a cross-sectional area and length thereof are appropriate (for example, a diameter of the wire ranging between 0.5 mm to 2 mm, and a length less than 50 cm) to control a total impedance of the electrostatic discharge path PA between 0.1Ω to 10Ω. The impedance range may ensure efficient electrostatic discharge while avoiding an instantaneous high current caused by an excessively low impedance. In addition, to ensure impedance stability, a surface of the conductor 140 and the electrical connector 112 may be applied with an anti-oxidation coating to prevent impedance increase due to oxidation during long-term usage. Through the foregoing measures, the device for discharging static electricity 100 of the disclosure may achieve safe and efficient electrostatic discharge in various electrostatic sensitive application scenes.

In the configuration of the foregoing embodiment, since the first battery 131 and the second battery 132 provide a stable direct current, the zero potential node N composed thereby may maintain an electrically “clean” 0V potential. Compared to a conventional solution where static electricity is imported into a building structure (such as a steel frame) through a ground line, since a material of the steel frame might have impurities or an oxidation layer, causing an overall conductivity to decrease, the method provided by the disclosure of establishing a zero potential reference point with a battery has better consistency and stability, facilitating more effective discharge of static charges and enhancing the effect of electrostatic discharge of a system.

In some exemplary embodiments, the device for discharging static electricity 100 may include the switch element 111, which is disposed on the outer box body 110a, and electrically connected to the conductor 140. The switch element 111 may be configured to switch an electrical connection state between the conductor 140 and the battery pack 130. Specifically, the switch element 111 may be electrically connected to the conductor 140 through elements such as wires, and configured in a current path between the conductor 140 and the battery pack 130, thereby implementing the function of controlling the conductor 140 to be turned on or turned off.

In a specific configuration, the switch element 111 may utilize a toggle switch. The switch has a two-state or three-state mechanical toggle structure, which may switch a closing and opening of an internal contact point through a toggling manner. When the user switches the toggle to a on position, the conductive structure on the inside of the toggle switch may close a current path, turning on an electrical circuit between the battery pack 130 and the conductor 140, allowing an electrostatic discharge mechanism to be activated. Conversely, when an off position is toggled thereto, the path is turned off and blocks a static current from entering the circuit. Through the design of controlling the switch element, the user may select to turn on or turn off the electrostatic release path PA according to actual detection and maintenance needs, enhancing the operational convenience of an overall system. In other embodiments, a rotary mechanical structure may be used to implement through a form of rotation to switch.

In some exemplary embodiments, the device for discharging static electricity 100 may further include an indicating light source 113 disposed on the outer box body 110a. The indicating light source 113 is configured to respond to an electrical connection state between the conductor 140 and the battery pack 130, thereby sending a corresponding visual indication signal. Specifically, the indicating light source 113 may be electrically connected to the conductor 140 through a wire or other conductive elements. When an electrical circuit between the conductor 140 and the battery pack 130 is turned on (for example, through the switch element 111 being switched to an on state), the indicating light source 113 may emit visible light due to current flow in the path, prompting the user that the current device for discharging static electricity 100 is in an activated state. Conversely, when the switch element 111 is switched to an off state, and the circuit is turned off, the indicating light source 113 may also be extinguished accordingly, indicating that the device for discharging static electricity 100 is currently in an inactivated state.

In some exemplary embodiments, the indicating light source 113 may include a light source element, which has a compact volume, and may be installed on the outer box body 110a of the device for discharging static electricity 100, such as a light emitting diode (LED), a miniature neon lamp, or other low power consumption and long-life visual indication elements. The light source element may serve as real-time indication of an operational state, and also enhance the user's intuitive recognition in operation and maintenance.

It should be noted that in the embodiment disclosed in FIG. 1, some elements (such as the switch 111, the electrical connector 112, and the indicating light source 113) are disposed on the outer box body 110a of the device for discharging static electricity 100. However, those skilled in the art should understand that the elements may also be disposed at other positions of the outer box body 110a (for example, on a side or bottom of the box body, or at least partially disposed within the receiving chamber 110b, etc.) to adapt to different design needs. Therefore, embodiments of configuration variation of the foregoing elements all fall within the protection scope of the disclosure.

In some exemplary embodiments, the outer box body 110a of the device for discharging static electricity 100 may be portable. Thus, the user may easily carry the device for discharging static electricity 100 and use in different working environments, greatly enhancing convenience and flexibility of usage. A portable design not only facilitates mobility, but also allows the user to quickly deploy at any time in scenes where electrostatic discharge is needed without relying on a fixed equipment installation position. In addition, such design facilitates space saving, and may be flexibly applied in different locations, such as laboratories, factories, or test sites, providing higher operational efficiency and operational flexibility.

In other exemplary embodiments, the outer box body 110a of the device for discharging static electricity 100 may be configured to be attached to a device to be electrostatic discharged (such as the detection device 20), ensuring that the device for discharging static electricity 100 is not prone to poor contact due to movement or collision during usage. Such attachment design effectively decreases physical displacement between devices, improves system stability and reliability, avoids the problem of poor contact caused by vibration or movement during operation, thereby ensuring stability and safety of an electrostatic discharge process.

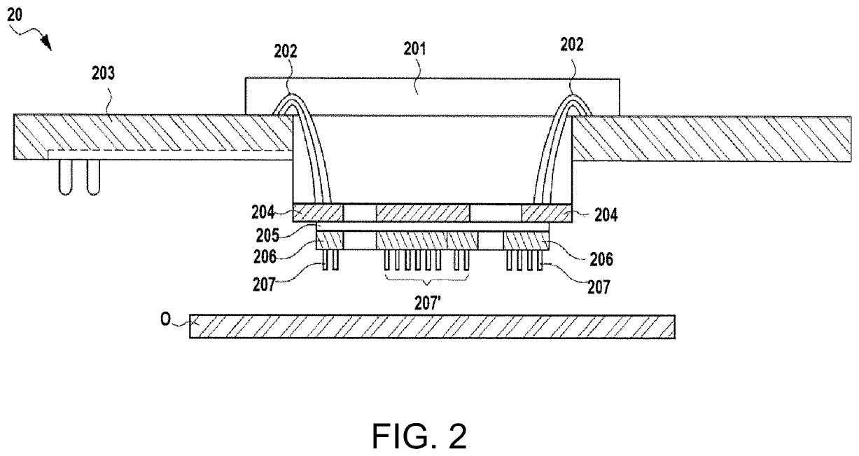

Please refer to FIG. 2, which is a schematic view of the detection device 20 according to an embodiment of the disclosure. In some embodiments, the detection device 20 may be configured to detect a test structure, a dimension, material characteristics, a circuit structure, or an electrical parameter of an object to be tested O. In some embodiments, the object to be tested O may be a chip, a wafer, a transistor, an integrated circuit, or other micro-nano level electronic elements.

In some exemplary embodiments, the detection device 20 may be a non-destructive detection tool, including but not limited to the following equipment: an atomic force microscope (AFM), a transmission electron microscope (TEM), a focused ion beam (FIB), a scanning probe microscopy (SPM), an electrostatic force microscopy (EFM), a scanning capacitance microscopy (SCM), and a scanning ion conductance microscope (SICM). In some embodiments, the detection device 20 may also be integrated into a complete test system or detection system. In addition, although in the embodiments described herein, the device for discharging static electricity 100 is primarily configured to discharge static charges accumulated on the detection device 20. In other embodiments, the device for discharging static electricity 100 may also be adapted to discharge static charges accumulated on other devices (such as a test equipment, an assembly equipment, a processing device, a bending needle device, or a load).

As shown in FIG. 2, a test end 201 of the detection device 20 is disposed on a substrate 203, and electrically connected to a connection unit 204 through a wire 202. The connection unit 204 further converts and transmits an electrical signal detected by a probe 207 (or a probe array 207′ formed by the probe 207) disposed on a probe head 206 through a space conversion unit 205, thereby executing electrical detection on the object to be tested O. In some embodiments, the space conversion unit 205 may be configured to change a direction, a spacing, or an arrangement of an electrical signal path to correspond to a configuration of an input end of the connection unit 204. In some exemplary embodiments, the probe 207 may be a micro probe, a nano probe, an angstrom probe, or other probes configured to detect a micro-nano level element. In the embodiment, the probe 207 may be assembled in at least one substrate (not shown in the figure). The probe 207 has a needle tip configured to contact the object to be tested O.

As described above, the device for discharging static electricity 100 of the disclosure is primarily configured to discharge static charges accumulated on the detection device 20. When the detection device 20 generates and accumulates static charges, the static electricity may be guided to the device for discharging static electricity 100 to be discharged through elements such as wires. However, since the element to be tested O is typically a precision electronic element, if an excessive current is applied, damage might be caused. To avoid generating an excessive instantaneous current during electrostatic discharge, which may cause damage to the element to be tested O, an electrostatic discharge current generated from the device for discharging static electricity 100 to the detection device 20 should be limited within an acceptable range. In some embodiments, a voltage value of an electrostatic discharge generated through the electrostatic discharge path PA may be controlled between 0V to 2.5V. In other embodiments, a voltage value of the electrostatic discharge may also be controlled within different ranges, such as 0V to 5V, 0V to 7.5V, or 0V to 10V. The foregoing voltage ranges may be adjusted according to actual electrostatic protection needs to have both the efficiency of electrostatic discharge and the safety of element usage.

Furthermore, in some embodiments, the detection device 20 may include an independent ground mechanism (not shown, such as a wire or other elements having similar functions). However, to avoid generating an excessive instantaneous current during an electrostatic discharge process and causing damage to the element to be tested O, when the device for discharging static electricity 100 is electrically coupled to the detection device 20, the ground mechanism does not form electrical connection with the device for discharging static electricity 100. Through the composition of the foregoing embodiments, the device for discharging static electricity 100 may implement effective electrostatic discharge in a condition where a controllable and low-risk discharge is maintained, and further protect the detection device 20 and the corresponding element to be tested to avoid potential or permanent damage caused by an excessive discharge current.

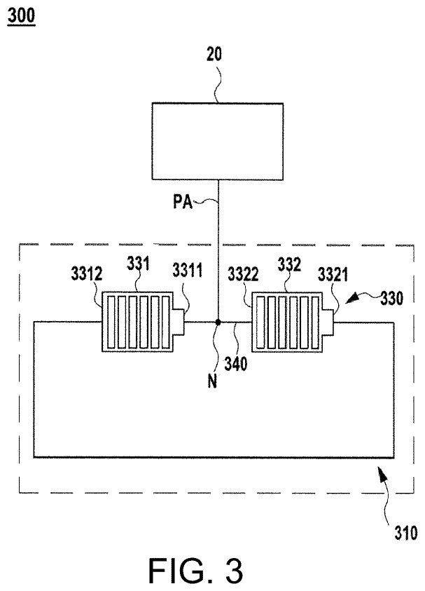

Please refer to FIG. 3, which is a schematic view of a device for discharging static electricity 300 according to a second embodiment of the disclosure. In the embodiment, the device for discharging static electricity 300 and the device for discharging static electricity 100 have at least partially the same or similar structures. The device for discharging static electricity 300 includes a battery pack 330 disposed in a receiving chamber 310. The battery pack 330 includes a first battery 331 and a second battery 332, and has a conductor 340 connected in series to the battery pack 330. When the conductor 340 is electrically connected to the battery pack 330 to form an electrical circuit, the zero potential node N may be established between a first electrode 3311 of the first battery 331 and a second electrode 3322 of the second battery 332. The detection device 20 may be electrically coupled to the zero potential node N through a wire or other elements having electrical conduction functions, thereby forming the electrostatic discharge path PA between the detection device 20 and the device for discharging static electricity 300. In addition, the device for discharging static electricity 300 may also include other elements the same or similar to the device for discharging static electricity 100 (such as an outer box body, a carrier, or an indicating light source), which will not be elaborated here.

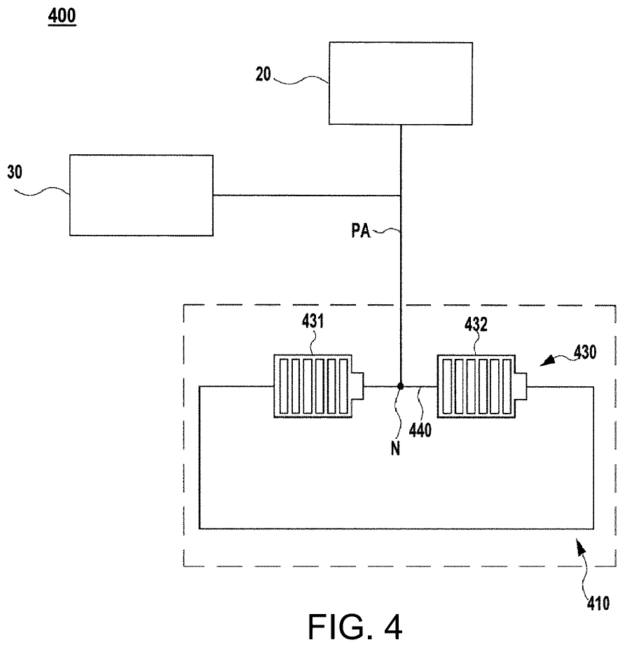

Please refer to FIG. 4, which is a schematic view of a device for discharging static electricity 400 according to a third embodiment of the disclosure. In the embodiment, the device for discharging static electricity 400 and the foregoing device for discharging static electricity 300 structurally have at least partially the same or similar constituent elements, including but not limited to, a configuration manner of a battery pack 430 (for example, including a first battery 431, a second battery 432 and each corresponding electrode) disposed in a receiving chamber 410, a configuration form of a conductor 440, and an electrical coupling mechanism between the detection device 20 and the zero potential node N.

A main difference between the embodiment and the foregoing device for discharging static electricity 300 is that the device for discharging static electricity 400 further includes an alert device 50 electrically connected to the electrostatic discharge path PA. Specifically, the alert device 50 may include an alarm and/or a display. In some exemplary embodiments, the alarm may be a speaker element such as a buzzer, or a light-emitting element such as an alert light source. Through the configuration of the foregoing embodiment, the alert device 50 may prompt the user in a visual or auditory manner whether an electrostatic discharge state is normal. When static electricity is not completely discharged or a system is abnormal, the display may show a corresponding identification screen, and send an alert by the alarm or the light-emitting element, prompting the user to perform corresponding inspection and handling.

To enhance the safety and operational convenience of the device for discharging static electricity 400, the disclosure further specifies a trigger condition and a function of the alert device 50. In some exemplary embodiments, the alert device 50 is configured to trigger an alert when the electrostatic discharge path PA is abnormal or a system state exceeds a safety range. A specific trigger condition includes but is not limited to: (1) an electrostatic discharge current exceeding a preset safety threshold, representing that static electricity is not completely discharged or there is an excessive current risk; (2) an electrostatic discharge voltage exceeding a safety range (for example, higher than 5V), which might cause damage to the element to be tested O; (3) a potential of the zero potential node N deviating from a preset range (for example, exceeding 0V±0.02V), indicating inconsistent battery voltage or circuit abnormality; and (4) a voltage of the battery pack 430 being lower than a preset value (for example, 80% of a rated voltage), indicating battery aging or insufficient power. The foregoing conditions are detected in real time by a current monitoring module, a voltage monitoring module, or a potential monitoring module (if any), and a detection result is transmitted to the alert device 50.

The alert device 50 may provide multiple alert types to intuitively prompt the user of a system state. In some embodiments, the alert device 50 includes a light-emitting element, such as a light-emitting diode (LED) disposed on an outer box body 410a. When an abnormality is detected, the LED may flash in different frequencies or colors according to an abnormality type. For example, red quick flashing represents a current exceeding a standard, and yellow slow flashing represents insufficient battery power. In addition, the alert device 50 may include a buzzer to serve as an auditory alert element. When electrostatic discharge is abnormal, the buzzer emits an intermittent high-frequency sound (for example, 1 kHz, lasting for 0.5 seconds, with a 1-second interval) to attract the user's attention. In some embodiments, the alert device 50 further includes a digital display, which is disposed on the outer box body, and configured to display a specific abnormal message, such as “abnormal current: 350 μA” or “low battery voltage: 2.4V”, providing more accurate state information.

An implementation of the alert device 50 is accomplished through hardware and software integration. In some exemplary embodiments, the alert device 50 is electrically connected to a control circuit on the carrier 410. The control circuit includes a microcontroller unit (MCU) and a related sensor (such as a current sensor or a voltage sensor). The microcontroller unit determines whether a trigger condition is satisfied according to a sensor data, and drives an LED, a buzzer, or a display to output a corresponding alert signal. To ensure the reliability of the alert device 50, a low-power and long-life component is used for a hardware element thereof. A circuit of the alert device 50 may be electrically coupled to the battery pack 430 through the conductor 440, using the battery pack 430 to provide power without an additional power module.

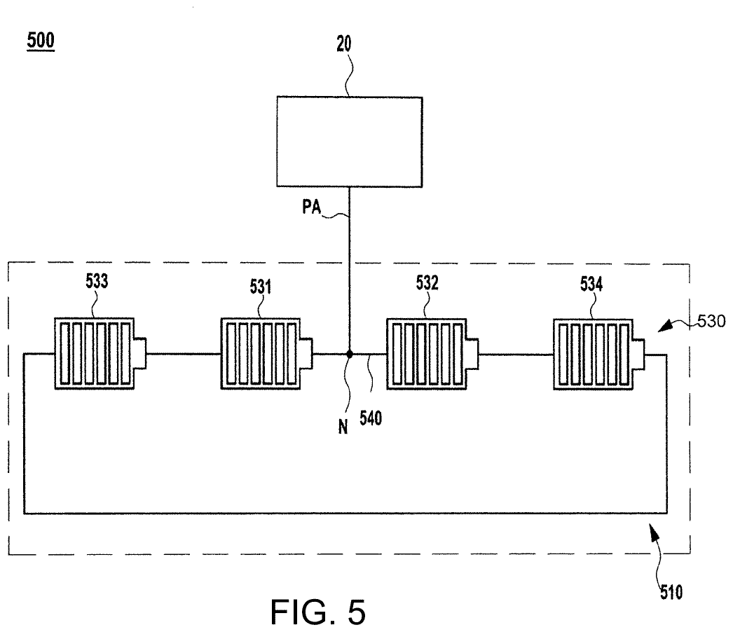

Please refer to FIG. 5, which is a schematic view of a device for discharging static electricity 500 according to a fourth embodiment of the disclosure. In the embodiment, the device for discharging static electricity 500 and the foregoing devices for discharging static electricity 300 and 400 structurally have at least partially the same or similar constituent elements, including but not limited to, a configuration form of a conductor 540 disposed in a receiving chamber 510, and an electrical coupling mechanism between the detection device 20 and the zero potential node N.

A main difference between the embodiment and the foregoing devices for discharging static electricity 300 and 400 is that a battery pack 530 utilized in the device for discharging static electricity 500, in addition to a first battery 531 and a second battery 532, further includes a third battery 533 and a fourth battery 534 connected in series in a same electrical circuit. Through the configuration of the foregoing embodiment, more steps of voltage setting range and more flexible electrostatic discharge condition selections may be provided, facilitating the enhancement of system adaptability and operational stability in response to different electrostatic protection needs. In addition, although the battery pack 530 shown in FIG. 5 only includes one third battery 533 and one fourth battery 534, those skilled in the art should understand that the battery pack 530 may also include more battery units paired and connected in series to achieve at least one zero potential node. Each node may be coupled to different detection devices 20. In other words, multi-node redundancy may serve multiple detection ports at the same time, or maintain the electrostatic discharge function when a single port malfunctions, improving system reliability. From other perspectives, an independent low-pass filter or an EMI suppression element may also be added between a zero potential node and the detection device 20, or the elements may be integrated into a microcontroller unit to eliminate high-frequency noise that might be introduced during a process of electrostatic discharge, automatically turned on the zero potential node when static electricity accumulation is detected to accomplish automatic discharge and automatically turned off after static electricity disappears.

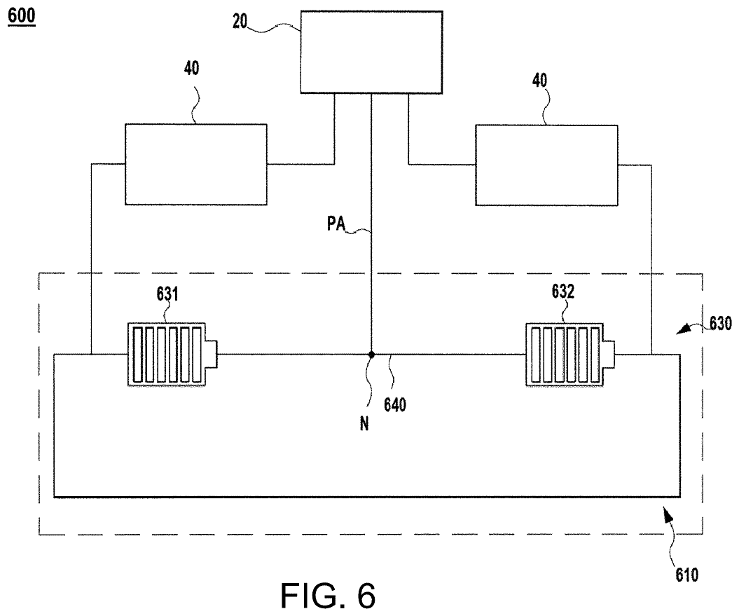

Please refer to FIG. 6, which is a schematic view of a device for discharging static electricity 600 according to a fifth embodiment of the disclosure. In the embodiment, the device for discharging static electricity 600 and the foregoing devices for discharging static electricity 300, 400, and 500 structurally have at least partially the same or similar constituent elements, including but not limited to, a configuration manner of a battery pack 630 (for example, including a first battery 631, a second battery 632 and each corresponding electrode) disposed in a receiving chamber 610, a configuration form of a conductor 640, and an electrical coupling mechanism between the detection device 20 and the zero potential node N.

A main difference between the embodiment and the foregoing devices for discharging static electricity 300, 400, and 500 is that the device for discharging static electricity 600 may further include an adjustment element 40. The adjustment element 40 may be electrically connected to the detection device 20 through a wire or other similar elements, and configured in an electrical circuit between the conductor 640 and the battery pack 630, thereby adjusting a resistance value between the detection device 20 and the electrical circuit. In some embodiments, the adjustment element 40 is configured for a user 60 to adjust within a voltage adjustment range (for example, 0V to 12V) provided by the battery pack 630.

In some embodiments, the adjustment element 40 may include at least one of passive elements, potentiometers, variable resistors, rheostats, thermistors, photoresistors, or other elements with adjustable resistance functions. In terms of an adjustment range, a resistance value provided by the adjustment element 40 may cover between 0.01Ω to 10MΩ. Through the foregoing configuration, the user may accurately fine-tune an electrostatic discharge path according to actual application needs to effectively control a rate of electrostatic discharge and a magnitude of a discharge current.

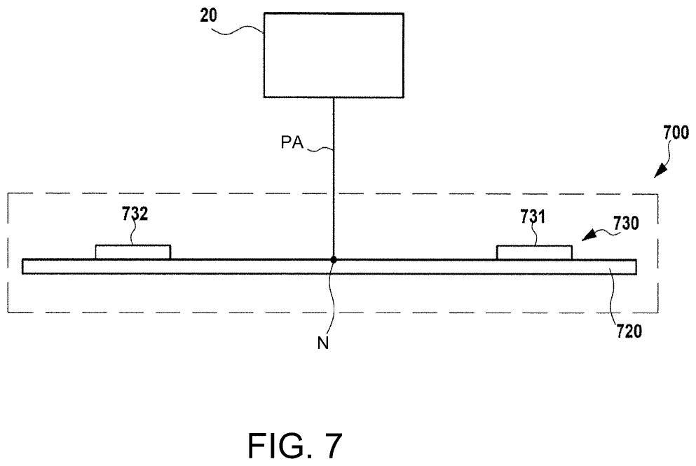

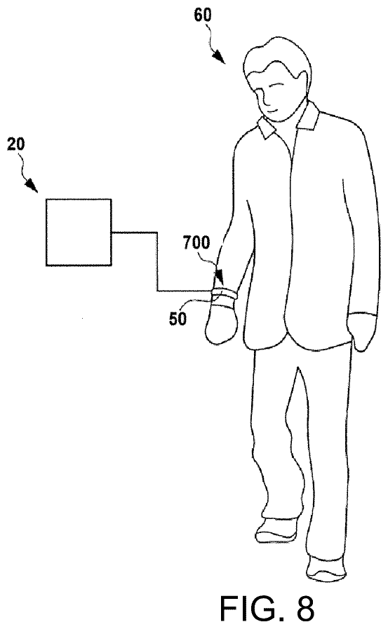

Please refer to FIG. 7 to FIG. 8, which are respectively a schematic view of a device for discharging static electricity 700 according to a sixth embodiment of the disclosure, and a schematic view of integrating the device for discharging static electricity 700 into a wearable device 50. In the embodiment, the device for discharging static electricity 700 and the foregoing devices for discharging static electricity 300, 400, 500, and 600 structurally have at least partially the same or similar constituent elements, including but not limited to, a configuration manner of a battery pack 730 (for example, including a first battery 731, a second battery 732 and each corresponding electrode), a configuration form of a conductor, and an electrical coupling mechanism between the detection device 20 and the zero potential node N, which will not be repeated here. FIG. 7 is a derivative example. The battery pack 730, a conductor and other elements in the device for discharging static electricity 700 may be formed on a carrier or formed on an inner surface of an outer box body in an in-mold forming manner.

A main difference between the embodiment and the device for discharging static electricity in the foregoing embodiment is that the first battery 731 and the second battery 732 in the battery pack 730 utilizes a form of battery panel. In some exemplary embodiments, the battery panel may be a perovskite battery and is carried and disposed on a flexible substrate 720 to provide stable power needed by the device. As shown in FIG. 8, the device for discharging static electricity 700 may be integrated into the wearable device 50 for the user to wear, thereby implementing a faster and more convenient electrostatic discharge operation. Through the wearable design, the user may continuously perform electrostatic protection while moving or operating an equipment without additional manual contact or operation of the device for discharging static electricity, further enhancing practicality and usage efficiency, particularly adapted for application scenes, such as electrostatic sensitive element handling, cleanroom operations, or high-frequency test operations. In one embodiment, the wearable device 50 may be provided with an electroluminescent display unit, which is configured to prompt that the electrostatic discharge path PA is abnormal or trigger an alert when a system state exceeds a safe range.

To ensure the safety of the device for discharging static electricity 700 when integrated into the wearable device 50, the disclosure provides multiple design measures to protect the user from potential risks of electrical or thermal effects. In some embodiments, the first battery 731 and the second battery 732 (such as a perovskite battery panel) in the battery pack 730 utilize a high insulation packaging material (such as a polyimide or silicone-based insulation layer) for overall cladding, ensuring complete isolation of a battery surface from human skin or the external environment. In addition, an electrode connection point of the battery panel utilizes a sealed design to prevent leakage risks caused by sweat, moisture, or other conductive media, thereby ensuring the electrical safety of the wearable device 50 during long-term usage.

For thermal effects that might be generated by an operation of the battery pack 730 or a circuit, the disclosure provides a thermal management design to ensure that the wearable device 50 meets the needs for a safe temperature of the human body. In some embodiments, a flexible substrate 720 utilizes a high thermal conductivity material (such as a graphene-containing composite substrate with a thermal conductivity greater than 100 W/m·K) to serve as a heat dissipation layer to quickly conduct heat generated by the battery pack 730 or a control circuit to the environment. In addition, an operating current of the battery pack 730 is controlled within a low power consumption range (for example, less than 50 mA) to decrease heat generation. In some embodiments, the wearable device 50 may include a temperature sensor (for example, a thermistor, disposed on the carrier 720), which is configured to monitor a surface temperature of the device. If the temperature exceeds a safety threshold (such as 40° C.), the control circuit may automatically reduce an output power of the battery pack 730 or suspend the electrostatic discharge function, thereby preventing thermal effects from causing discomfort or harm to the user skin.

Please refer to FIG. 1 to FIG. 8. The disclosure further provides a method for discharging static electricity. The method may be implemented using an element of any one of the devices for discharging static electricity 100, 300, 400, 500, 600, and 700 or a combination thereof. The method includes that: a battery pack is disposed on a carrier; a conductor is connected in series to a first battery and a second battery in the battery pack; the conductor is turned on with the first battery and the second battery to form an electrical circuit, and a zero potential node is formed between a first electrode of the first battery and a second electrode of the second battery; the zero potential node is electrically coupled to a detection device; and a static electricity generated by the detection device is discharged to the zero potential node through an electrostatic discharge path formed between the detection device and the zero potential node.

In some application scenes, the device for discharging static electricity may be designed as a portable structure to facilitate an operator to bring along for usage. For practitioners in a probe-related field, whether in producing probes, assembling probe heads, manufacturing probe cards (such as vertical, cantilever, MEMS probes, POGO PIN, spring pins, buckling pins, or wire probes), or in a process of assembling probes to be compatible with a space conversion plate, the device may be flexibly used. Furthermore, the device may also be applied in a process such as executing a detection, analysis, maintenance and cleaning of an object to be tested using a probe. The application scope is not limited to probes and probe cards, but may also cover semiconductor or wafer detection systems, integrated circuit detection systems, and may be extended to probe sockets, probe connection assemblies, and other equivalent fields of non-solid-state detection objects, such as laser integrated circuits, silicon photonic integrated circuits, slice analysis, and those that may be regarded as the detection device 20.

In addition, in some exemplary embodiments, the battery pack may further include a “stretchable battery” to respond to application needs for flexible or stretchable power, such as wearable electronic products, medical patches, electronic skin (e-skin), or soft robots. Known stretchable battery technologies include manufacturing conventional rigid battery materials (such as lithium-ion battery electrodes) into wavy, mesh, or serpentine structures. When a material is stretched, a wavy structure may be expanded to maintain conductive and stretching characteristics. Related research has confirmed that, for example, the University of Illinois in the United States has published a stretchable lithium-ion battery. Another exemplary manner is to utilize a flexible and conductive material, such as conductive polymers (such as PEDOT:PSS), carbon nanotubes or graphene films, to serve as electrodes, and combine with substrates such as silicone and PU elastomers, allowing the battery to be stretched and directly worn on a body part of the operator. At the same time, research has also utilized a liquid electrolyte or an ionic liquid to replace a conventional solid diaphragm in conjunction with an elastic packaging material, allowing the battery to maintain performance under a bending or stretching condition. Some research has even utilized a liquid metal (such as gallium alloys) to serve as a conductor, having both flexibility and high conductivity.

Through the foregoing design, after combining with the portable and wearable structure, the device for discharging static electricity of the disclosure can provide higher convenience, expandability and safety in various fields of probe application and electrostatic sensitive element detection.

In summary, the disclosure is positioned at the electrostatic protection technology in the field of semiconductor detection, in particular designed for micro-nano level element detection, analysis or related product assembly processes. Through a specific device for discharging static electricity, assembly accuracy is demanded for an objected to be tested and a detection object, a semiconductor object to be analyzed, or a probe-related product, and electrostatic interference and damage is avoided. A point of innovation of the technology is the design of a zero potential node, which uses a counteracting potential point formed by two batteries connected in series to serve as an independent and stable electrostatic discharge end, instead of relying on a form of conventional ground or plasma diffusion and catharsis. At the same time, a voltage consistency control mechanism is used in conjunction, including screening of batteries with a same specification, a voltage balance circuit, and state monitoring to ensure stability of long-term operation. An outer box body with a Faraday cage structure is used in conjunction to implement the anti-interference effect, maintaining the zero potential node at 0V±0.01V. In addition, the design has modularity characteristics, which may be directly coupled to a probe detection device, and extended to a wearable device and multiple applications scenes. Based on the above, the disclosure can thoroughly discharge static electricity, avoid a micro-nano element from being damaged, enhance the accuracy and reliability of electrical detection, analysis, or assembly, and decrease misjudgment and failure caused by ESD, thereby improving product yield, ensuring quality of a final product, and at the same time strengthening the stability of a device in different environments. The convenience and safety of operation can be enhanced through battery state display and alert functions, enhancing the efficiency and reliability of a semiconductor detection process in an overall manner.

Please refer to FIG. 1 to FIG. 8. The disclosure further provides a manufacturing system. The manufacturing system is configured to manufacture a probe card. The manufacturing system provides multiple probes, and assembles the multiple probes on a guide plate and a space conversion unit. The manufacturing system includes the device for discharging static electricity in any one of the foregoing embodiments.

Please refer to FIG. 1 to FIG. 8. The disclosure further provides a manufacturing system. The manufacturing system is configured to manufacture a probe holder. The manufacturing system provides multiple probes, assembles the multiple probes on a guide plate and a space conversion unit with a frame (or a casing), and is electrically connected to a detection device. The manufacturing system includes the device for discharging static electricity in any one of the foregoing embodiments. The device for discharging static electricity has two batteries connected in series to form an offsetting electrical point.

Please refer to FIG. 1 to FIG. 8. The disclosure further provides a manufacturing system. The manufacturing system is configured to provide a probe card to analyze an object to be tested. The probe card provides multiple probes, assembles the multiple probes on a guide plate and a space conversion unit, and analyzes at least one object to be tested through at least one needle tip of the multiple probes. The manufacturing system includes the device for discharging static electricity in any one of the foregoing embodiments. The object to be tested includes at least one of a wafer, a die, a package element, and an integrated circuit.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure.

What is claimed is:

1. A device for discharging static electricity, comprising:
a receiving chamber;
a battery pack, disposed in the receiving chamber, wherein the battery pack comprises a first battery and a second battery connected in series with each other, each of the first battery and the second battery has a first electrode and a second electrode;
a conductor, connected in series to the battery pack, wherein the conductor comprises a zero potential node located between the first electrode of the first battery and the second electrode of the second battery;
a switch, electrically connected to the conductor, and configured to switch an electrical connection state between the conductor and the battery pack; and
an electrical connector, electrically connected to the zero potential node, and coupled to a detection device to allow an electrostatic discharge path to be formed between the zero potential node and the detection device.

2. The device for discharging static electricity according to claim 1, wherein a quantity of batteries comprised in the battery pack is an even number.

3. The device for discharging static electricity according to claim 1, wherein the conductor comprises at least one of a wire, a conductive pattern, a conductive sheet, a conductive adhesive, a conductive tape, a conductive fabric, and a conductive foam.

4. The device for discharging static electricity according to claim 1, further comprising:
an indicating light source, configured to send an indication signal in response to the electrical connection state.

5. The device for discharging static electricity according to claim 1, further comprising:
a portable outer box body having the receiving chamber.

6. The device for discharging static electricity according to claim 1, further comprising:
an outer box body having the receiving chamber, configured to be attached and fixed to the detection device.

7. The device for discharging static electricity according to claim 1, wherein the detection device has a probe configured to detect a micro-nano level element.

8. The device for discharging static electricity according to claim 1, wherein a voltage value of an electrostatic discharge generated through the electrostatic discharge path is less than 10 volts.

9. The device for discharging static electricity according to claim 1, further comprising:
an alert device, electrically connected to the electrostatic discharge path, and configured to reflect an electrostatic discharge state of the electrostatic discharge path.

10. The device for discharging static electricity according to claim 1, wherein the battery pack further comprises: at least one third battery connected in series to the second electrode of the first battery, and at least one fourth battery connected in series to the first electrode of the second battery, wherein a quantity of the at least one third battery is equal to a quantity of the at least one fourth battery.

11. The device for discharging static electricity according to claim 1, further comprising: an adjustment element, electrically connected to the conductor and the detection device, and configured to adjust a resistance value between the conductor and the detection device.

12. A device for discharging static electricity, comprising:
a battery pair, comprising two batteries connected in series with each other; and
a conductor, connected in series to the battery pair to form an electrical circuit, and forming a zero potential node between opposite electrodes of the battery pair;
wherein the zero potential node is configured to be electrically coupled to a detection device to form an electrostatic discharge path.

13. The device for discharging static electricity according to claim 12, wherein the detection device is configured to use a probe to detect a micro-nano level element.

14. The device for discharging static electricity according to claim 12, wherein a voltage value of an electrostatic discharge generated through the electrostatic discharge path is less than 10 volts.

15. The device for discharging static electricity according to claim 12, further comprising: a portable box body accommodating a carrier carrying the battery pair therein, wherein the battery pair is electrically connected to the carrier.

16. The device for discharging static electricity according to claim 15, wherein an outer surface of the portable box body is provided with a switch, configured to turn on or turn off the electrical circuit.

17. The device for discharging static electricity according to claim 16, wherein the outer surface of the portable box body is provided with an indicating light source, configured to send an indication signal in response to an electrical connection state of the electrical circuit.

18. The device for discharging static electricity according to claim 12, wherein the battery pair comprises a battery panel, and is mounted on a flexible substrate.

19. The device for discharging static electricity according to claim 18, wherein the device for discharging static electricity is configured to be integrated into a wearable device.

20. A method for discharging static electricity, comprising:
providing a battery pack;
providing a conductor, wherein the conductor is connected in series with a first battery and a second battery in the battery pack;
turning on the conductor, the first battery and the second battery to form an electrical circuit, and forming a zero potential node between a first electrode of the first battery and a second electrode of the second battery;
electrically coupling the zero potential node to a detection device; and
discharging a static electricity generated by the detection device to the zero potential node through an electrostatic discharge path formed between the detection device and the zero potential node;
wherein the detection device has a probe configured to detect a micro-nano level element.
